(19) United States
(12) Patent Application Publication
(10) Pub. No.: US 2012/0254556 A1
(43) Pub. Date: Oct. 4, 2012

(54) CONTROL APPARATUS, STORAGE SYSTEM, AND CONTROL METHOD

(75) Inventor: Nobuyuki HONJO, Tama (JP)

(73) Assignee: FUJITSU LIMITED, Kawasaki-shi (JP)

(21) Appl. No.: 13/419,962

(22) Filed: Mar. 14, 2012

(30) Foreign Application Priority Data
Mar. 30, 2011 (JP) 2011-076216

(51) Int. Cl. G06F 12/00

(52) U.S. Cl. 711/154; 711/E12.001

(57) ABSTRACT

In a storage system, a storage unit of a control apparatus stores first connection information indicating a device connected to a subordinate of the control apparatus. A controller acquires second connection information, created by a relay device, indicating a device connected to the relay device, compares the acquired second connection information and the first connection information stored in the storage unit, and transmits a reset instruction on the second connection information to the relay device based on a comparison result.

### CROSS-REFERENCE TO RELATED APPLICATION

This application is based upon and claims the benefit of priority of the prior Japanese Patent Application No. 2011-076216, filed on Mar. 30, 2011, the entire contents of which are incorporated herein by reference.

### FIELD

The embodiments discussed herein are related to a control apparatus, a storage system, and a control method.

### BACKGROUND

There is widely used a storage system having a storage device which stores data by using a storage medium such as a magnetic disk, an optical disk, and a semiconductor memory, and a CM (Controller Module) which controls writing of data to a storage device or reading of data from the storage device. In addition to a storage device and a CM, a storage system may have a relay device such as a SAS (Serial Attached SCSI) expander, which is serially connected between the storage device and the CM, and relays an access between the storage device and the CM.

A relay device of a storage system may be connected to a relay device or storage device by using connection information stored in a routing table.

With regard to connection control of a storage system having a relay device, the following technology is known.

Japanese Laid-open Patent Publication No. 2008-242872

Japanese Laid-open Patent Publication No. 2009-181317

The above-described relay device may operate in an SD (Self-DISCOVER) mode in which a DISCOVER process is performed by its own device and other devices are set in routing tables, and operate in an NSD (Non-Self-DISCOVER) mode in which the DISCOVER process is not performed by its own device and a routing table created by other devices such as a CM is set in its own device.

Here, when one relay device operating in the SD mode and another relay device operating in the NSD mode are mixedly connected to a CM, a routing table for the relay device operating in the SD mode may fail to be correctly created.

Suppose, for example, that when a storage device is newly connected to a storage system, a relay device operating in the SD mode creates a routing table. At this time, in the case where timing at which the relay device creates a routing table is early, when a newly connected storage device is not set in the routing table for the relay device which is present between the relay device and the newly connected storage device, the newly connected storage device is not set in the routing table for the relay device.

As can be seen from the above discussion, a part of relay devices and storage devices may fail to be recognized in the relay device operating in the SD mode. As described above, connection information may fail to be correctly created in the relay device operating in the SD mode.

### SUMMARY

According to an aspect, there is provided a control apparatus for performing data access to a storage device by the relay of data access of a relay device. This control apparatus includes a memory configured to store first connection information indicating devices connected to subordinates of the control apparatus; and a processor configured to acquire second connection information, created by the relay device, indicating devices connected to the relay device, compare the acquired second connection information and the first connection information stored in the memory, and transmit a reset instruction on the second connection information to the relay device based on a comparison result.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a storage system according to a first embodiment;

FIG. 2 illustrates hardware of a storage system according to a second embodiment;

FIG. 3 illustrates connection between a controller, expanders, and storage devices of a storage system according to a second embodiment;

FIG. 4 illustrates a routing table for a controller according to a second embodiment;

FIGS. 5A to 5D illustrate routing tables for expanders according to a second embodiment;

FIG. 6 illustrates comparison between routing tables according to a second embodiment;

FIG. 7 illustrates comparison between routing tables according to a second embodiment;

FIG. 8 illustrates routing table setting processing according to a second embodiment;

FIG. 9 illustrates routing table comparison processing according to a second embodiment;

FIG. 10 illustrates routing table comparison processing of a modification of a second embodiment; and

FIG. 11 illustrates routing table comparison processing of a modification of a second embodiment.

### DESCRIPTION OF EMBODIMENTS

Several embodiments will be described below with reference to the accompanying drawings, wherein like reference numerals refer to like elements throughout.

### First Embodiment

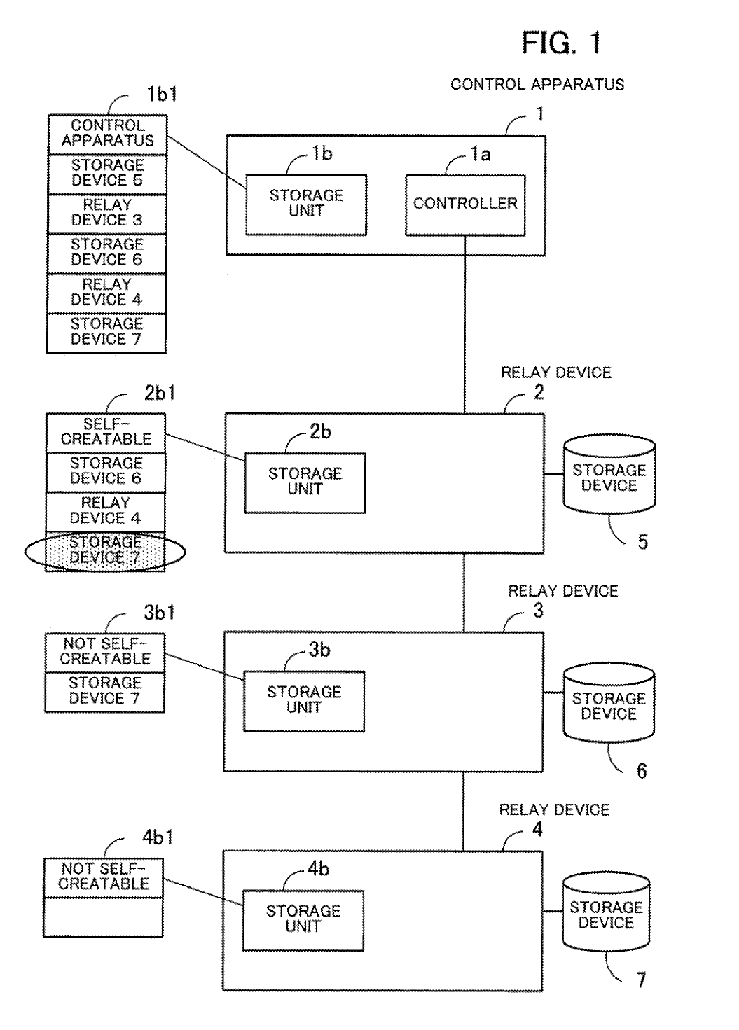

FIG. 1 illustrates a storage system according to a first embodiment. The illustrated storage system includes a control apparatus 1, relay devices 2, 3, and 4, and storage devices 5, 6, and 7.

The control apparatus 1 accesses data to the storage devices 5 to 7 by the relay of data access of the relay devices 2 to 4. The control apparatus 1 includes a controller 1a and a storage unit 1b.

Here, in the first embodiment, when a new device (e.g., the storage device 7) is supposed to be connected to the relay device 4, the relay device 2 acquires connection information 3b1 of a subordinate relay device (e.g., the relay device 3) by its own device. Based on the acquired connection information 3b1, the relay device 2 is supposed to create connection information 2b1 including a device newly connected to a subordinate, and store it in the storage unit 2b (self-creatable). On the other hand, when a new device (e.g., the storage device 7) is connected to the relay device 4, each of the relay devices 3 and 4 is supposed to receive connection information created for its own device by the control apparatus 1, and store it in the storage units 3b and 4b, without creating the connection information 3b1 and 4b1 by its own device (not self-creatable).

The controller 1a acquires the connection information 2b1, created by the self-creatable relay device 2, indicating devices connected to the relay device 2, and compares the acquired connection information 2b1 and the connection information 1b1 stored in the storage unit 1b. Based on comparison results, the controller 1a transmits a reset instruction on the connection information 2b1 to the relay device 2.

The storage unit 1b stores the connection information 1b1 indicating devices connected to subordinates of the control apparatus 1. Suppose here that each connection information indicates devices indirectly connected to its own device via other devices. The connection information may include, but without being limited thereto, a device directly connected to its own device. For example, when a power switch of the storage system is turned on, the controller 1a collects connection states of the relay devices 2 to 4 and creates the connection information 1b1. Suppose that the connection state of the storage system is changed in the case where a new device is connected to the storage system. In this case, when the controller 1a detects a change of the connection state, the connection information 1b1 is updated based on the change.

The relay devices 2 to 4 have the storage units 2b to 4b, respectively. The relay devices 2 to 4 are further connectable to the storage devices 5 to 7, respectively. The relay devices 2 to 4 are connected to other devices based on the connection information 2b1 to 4b1 stored in the storage units 2b to 4b, respectively.

The storage units 2b to 4b store connection information indicating devices connected to subordinates of the relay devices 2 to 4, respectively.

The storage devices 5 to 7 store user data, and read and write stored data based on an access of the control apparatus 1.

In this case, depending on creation timing of the connection information 2b1 through the relay device 2, a failure may occur in the connection information 2b1. For example, when the storage device 7 is newly connected to the relay device 4, before the connection information 3b1 of the relay device 3 is updated by the control apparatus 1, the connection information 2b1 is created by the relay device 2. In this case, the storage device 7 is not set to the connection information 3b1 at the time when the relay device 2 acquires the connection information 3b1. Therefore, at this time, when the relay device 2 creates the connection information 2b1 based on the connection information 3b1, the storage device 7 may fail to be set to the connection information 2b1 and the relay device 2 may fail to access the storage device 7.

As compared with the above, when detecting that the storage device 7 is connected to a subordinate as a new device, the controller 1a compares the connection information 2b1 created by the relay device 2 and the connection information 1b1 created by the control apparatus 1. When both of the connection information 2b1 and 1b1 are not matched with each other, the controller 1a transmits a reset instruction on the connection information 2b1 to the relay device 2. As a result, the connection information 2b1 is created by the relay device again, and the connection of the storage device 7 is reflected on the connection information 2b1.

As can be seen from the above discussion, the first embodiment makes it possible to eliminate abnormality of connection information of the relay device 2.

### Second Embodiment

Next, an embodiment in which the storage system according to the first embodiment is more specifically configured will be described as a second embodiment.

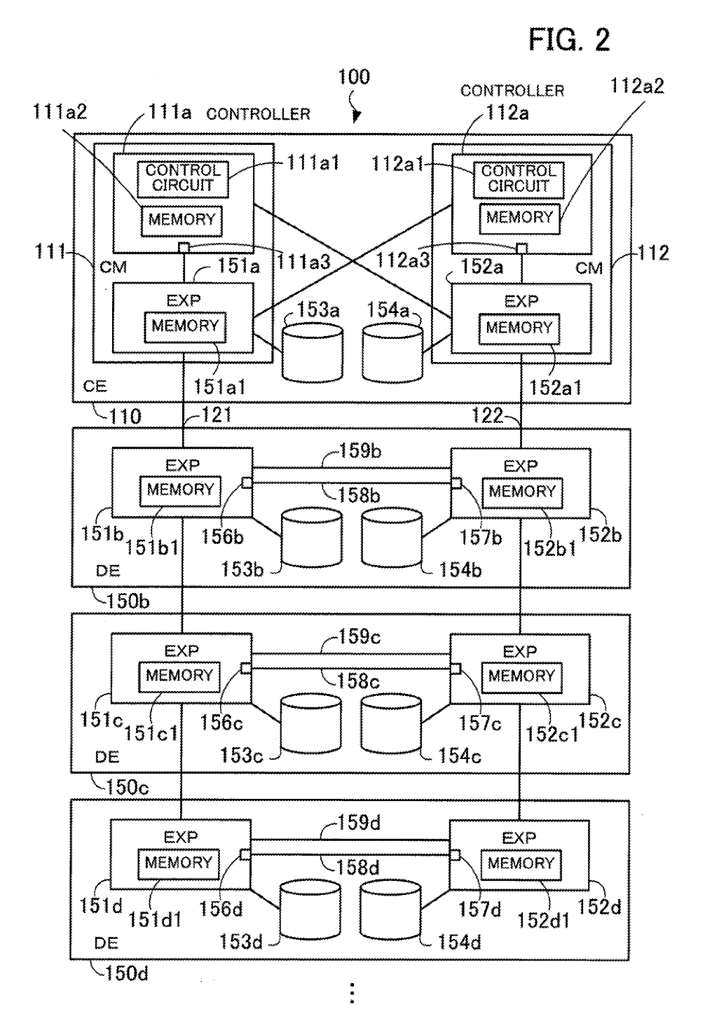

FIG. 2 illustrates hardware of a storage system according to the second embodiment. The storage system 100 includes a CE (Controller Enclosure) 110 having two controllers 111a and 112a. The storage system 100 further includes a plurality of DEs (Drive Enclosure) 150b, 150c, and 150d.

The CE 110 and the DEs 150b to 150d have storage devices 153a, 154a, 153b, 154b, 153c, 154c, 153d, and 154d, respectively.

The DEs 150b to 150d are serially connected to two data transmission paths 121 and 122 respectively connected to the controllers 111a and 112a. Examples of the data transmission paths 121 and 122 include an SAS. Here, the number of the DEs 150b to 150d is not limited to three, and the DEs are arbitrarily set, for example, according to needed storage capacity.

The DE 150b will be first described. The DE 150b has an EXP (Expander) 151b having a memory 151b1, an EXP 152b having a memory 152b1, and the storage devices 153b and 154b which store data. Examples of the storage devices 153b and 154b include an HDD (Hard Disk Drive) and an SSD (Solid State Drive).

The EXPs 151b and 152b are connected to the storage devices 153b and 154b via the data transmission paths such as an SAS, respectively. The EXP 151b is serially connected to the data transmission path 121, and the EXP 152b is serially connected to the data transmission path 122. The EXP 151b relays data access from the controller 111a to the storage device 153b. The EXP 152b relays data access from the controller 112a to the storage device 154b.

Between the EXPs 151b and 152b, a communication path 159b is provided. Examples of the communication path 159b include I²C (trademark) and Ethernet (registered trademark). Further, on the EXP 151b, an inter-expander port 156b is provided, and an inter-expander port 157b is provided on the EXP 152b.

Between the EXPs 151b and 152b, an inter-expander data transmission path 158b connected between the inter-expander ports 156b and 157b is provided. Examples of the inter-expander data transmission path 158b include an SAS.

The memory 151b1 stores a routing table which stores one state in which both the EXP 151b and the controller 111a or both the EXP 151b and the controller 112a are connected or not yet connected, and another state in which the EXP 151b and the storage device 153b are connected. This routing table further stores one connection state between the EXPs 151b and 152b, and another connection state between the EXP 152b and the storage device 154b. The connection states are further set in this routing table so as to include routing tables for subordinate expanders connected to the EXP 151b. As described later in detail, since operating in an SD mode, the EXP 151b refers to the routing table stored in the memory 151c1 of the subordinate EXP 151c and sets a connection state in a subordinate of its own device in the routing table for its own device.

The memory 152b1 stores a routing table which stores one connection state between the EXP 152b and the controller 111a or between the EXP 152b and the controller 112a, and another connection state between the EXP 151b and the storage device 154b. This routing table further stores one connection state between the EXPs 151b and 152b, and another connection state between the EXP 151b and the storage device 153b. The connection states are further set in this routing table so as to include the routing tables for subordinate expanders connected to the EXP 152b.

The EXP 151b monitors a connection state between the EXP 151b and each of the storage devices 153b and 154b and subordinate expanders connected to the data transmission path 121. In the case where a device is newly connected to a subordinate and the connection of the connected device is released, for example, when a change occurs in this connection state, the EXP 151b detects it. The EXP 151b then notifies the controller 111a or 112a of this change in the connection state via the data transmission path 121.

The EXP 151b further updates the routing table stored in the memory 151b1 according to an instruction from the controller 111a or 112a. The EXP 151b further notifies the controller 111a or 112a of the updated routing table.

The EXP 152b monitors a connection state between the EXP 152b and each of the storage devices 153b and 154b and subordinate expanders connected to the data transmission path 122 and, when a change occurs in this connection state, detects it. The EXP 152b then notifies the controller 111a or 112a of this detected change in the connection state via the data transmission path 122.

The EXP 152b further updates the routing table stored in the memory 152b1 according to an instruction from the controller 111a or 112a. The EXP 152b then notifies the controller 111a or 112a of the updated routing table.

Next, the DE 150c will be described. The DE 150c has an EXP 151c having a memory 151c1, an EXP 152c having a memory 152c1, and the storage devices 153c and 154c which store data.

The EXPs 151c and 152c are connected to the storage devices 153c and 154c via the data transmission path such as an SAS, respectively. The EXP 151c is serially connected to the data transmission path 121, and the EXP 152c is serially connected to the data transmission path 122. The EXPs 151c and 152c relay data access from the controller 111a and 112a to the storage devices 153c and 154c, respectively.

Between the EXPs 151c and 152c, a communication path 159c is provided. Examples of the communication path 159c include I²C (trademark) and Ethernet (registered trademark). Further, on the EXP 151c, an inter-expander port 156c is provided, and an inter-expander port 157c is provided on the EXP 152c.

Between the EXPs 151c and 152c, an inter-expander data transmission path 158c connected to the inter-expander ports 156c and 157c is provided. Examples of the inter-expander data transmission path 158c include an SAS.

The memory 151c1 stores a routing table in which one connection state between the EXP 151c and the controller 111a or between the EXP 151c and the controller 112a, and another connection state between the EXP 151c and the storage device 153c. This routing table further stores one connection state between the EXPs 152c and 151c, and another connection state between the EXP 152c and the storage device 154c. The connection states are further set in this routing table so as to include the routing table for an expander of a subordinate connected to the EXP 151c. As described later in detail, since operating in an NSD mode, the EXP 151b sets the routing table created by the controller 111a to the routing table for its own device.

The memory 152c1 stores a routing table which stores one connection state between the EXP 152c and the controller 111a or between the EXP 152c and the controller 112a, and another connection state between the EXP 152c and the storage device 154c. This routing table further stores one connection state between the EXPs 151c and 152c, and another connection state between the EXP 151c and the storage device 153c. The connection states are further set in this routing table so as to include the routing table for a subordinate expander connected to the EXP 152c.

A function of the EXP 151c is the same as that of the EXP 151b of the DE 150b. A function of the EXP 152c is the same as that of the EXP 152b of the DE 150b.

Next, the DE 150d will be described. The DE 150d has an EXP 151d having a memory 151d1, an EXP 152d having a memory 152d1, and the storage devices 153d and 154d which store data.

The EXPs 151d and 152d are connected to the storage devices 153d and 154d via the data transmission paths such as an SAS, respectively. The EXP 151d is serially connected to the data transmission path 121, and the EXP 152d is serially connected to the data transmission path 122. The EXPs 151d and 152d relay data access from the controllers 111a and 112a to the storage devices 153d and 154d, respectively.

Between the EXPs 151d and 152d, a communication path 159d is provided. Examples of the communication path 159d include I²C (trademark) and Ethernet (registered trademark). Further, an inter-expander port 156d is provided on the EXP 151d, and an inter-expander port 157d is provided on the EXP 152d.

Between the EXPs 151d and 152d, an inter-expander data transmission path 158d connected to the inter-expander ports 156d and 157d is provided. Examples of the inter-expander data transmission path 158d include an SAS.

The memory 151d1 stores a routing table which stores one connection state between the EXP 151d and the controller 111a or between the EXP 151d and the controller 112a, and another connection state between the EXP 151d and the storage device 153d. This routing table further stores one connection state between the EXPs 152d and 151d, and another connection state between the EXP 152d and the storage device 154d. The connection states are further set in this routing table so as to include the routing table for a subordinate expander connected to the EXP 151d.

The memory 152d1 stores a routing table which stores one connection state between the EXP 152d and the controller 111a or between the EXP 152d and the controller 112a, and another connection state between the EXP 152d and the storage device 154d. This routing table further stores one connection state between the EXPs 151d and 152d, and another connection state between the EXP 151d and the storage device 153d. The connection states are further set in this routing table so as to include the routing table for a subordinate expander connected to the EXP 152d.

A function of the EXP 151d is the same as that of the EXP 151c of the DE 150c. A function of the EXP 152d is the same as that of the EXP 152c of the DE 150c.

Next, the CE 110 will be described. The CE 110 has CMs (Control Module) 111 and 112, and the storage devices 153a and 154a which store data. Further, examples of the storage devices 153a and 154a include an HDD and an SSD.

The CM 111 has a controller 111a and the EXP 151a having the memory 151a1. The CM 112 has a controller 112a and the EXP 152a having the memory 152a1.

The controller 111a and the EXP 151a are connected to the data transmission path 121, and the controller 112a and the EXP 152a are connected to the data transmission path 122. The controller 111a is further connected to the EXP 152a via the data transmission path such as an SAS. The controller 112a is further connected to the EXP 151a via the data transmission path such as an SAS.

The EXPs 151a and 152a are connected to the storage devices 153a and 154a via the data transmission path such as an SAS, respectively. The EXP 151a relays data transmission between the storage device 153a and the controller 111a or between the storage device 153a and the controller 112a. The EXP 152a relays data transmission between the storage device 154a and the controller 111a or between the storage device 154a and the controller 112a.

The memory 151a1 stores a routing table which stores one connection state between the EXP 151a and the controller 111a or between the EXP 151a and the controller 112a, and another connection state between the EXP 151a and the storage device 153a. The connection states are further set in this routing table so as to include the routing table for the subordinate EXP 151b connected to the data transmission path 121.

The memory 152a1 stores a routing table which stores one connection state between the EXP 152a and the controller 111a or between the EXP 152a and the controller 112a, and another connection state between the EXP 152a and the storage device 154a. The connection states are further set in this routing table so as to include the routing table for the subordinate EXP 152b connected to the data transmission path 122.

The EXP 151a updates the routing table stored in the memory 151a1 according to an instruction from the controller 111a or 112a. The EXP 151a further notifies the controller 111a or 112a of the updated routing table.

The EXP 151a monitors a connection state between the EXP 151a and each of the storage device 153a and the subordinate EXP 151b connected to the data transmission path 121. When a change occurs in this connection state, the EXP 151a detects it. The EXP 151a then notifies the controller 111a or 112a of this change in the connection state.

The EXP 152a further updates the routing table stored in the memory 152a1 according to an instruction from the controller 111a or 112a. The EXP 152a further notifies the controller 111a or 112a of the updated routing table.

The EXP 152a monitors a connection state between the EXP 152a and each of the storage device 154a and the subordinate EXP 152b connected to the data transmission path 122. When a change occurs in this connection state, the EXP 152a detects it. The EXP 152a then notifies the controller 111a or 112a of this change in the connection state.

The controller 111a has a control circuit 111a1, a memory 111a2, and a communication port 111a3. Processing through the controller 111a is performed by the control circuit 111a1. For example, the control circuit 111a1 includes a CPU (Central Processing Unit). To the communication port 111a3, the data transmission path 121 is connected.

The controller 112a has a control circuit 112a1, a memory 112a2, and a communication port 112a3. Processing through the controller 112a is performed by the control circuit 112a1. For example, the control circuit 112a1 includes a CPU. To the communication port 112a3, the data transmission path 122 is connected.

The controllers 111a and 112a perform the following processing via the data transmission path going through a part of the EXPs 151a to 151d, and 152a to 152d, respectively. Specifically, the controllers 111a and 112a write data in each of the storage devices 153a to 153d, and 154a to 154d, and further read data from each of the storage devices 153a to 153d, and 154a to 154d, respectively. This processing is performed, for example, according to an instruction from a host device (not illustrated).

Further, when receiving a notification of a change in the connection state from any of the EXPs 151a to 151d, and 152a to 152d, the controllers 111a and 112a perform the following processing, respectively. Specifically, the controllers 111a and 112a instruct all of the EXPs 151a to 151d, and 152a to 152d to update the routing table, respectively.

The controllers 111a and 112a further acquire all the routing tables for the EXPs 151a to 151d, and 152a to 152d, respectively. The controllers 111a and 112a store the acquired routing tables in the memories 111a2 and 112a2, respectively. Further, the controllers 111a and 112a refer to the routing tables acquired and stored in the memories 111a2 and 112a2, and monitor connection conditions to each of the storage devices 153a to 153d, and 154a to 154d via the data transmission paths 121 and 122.

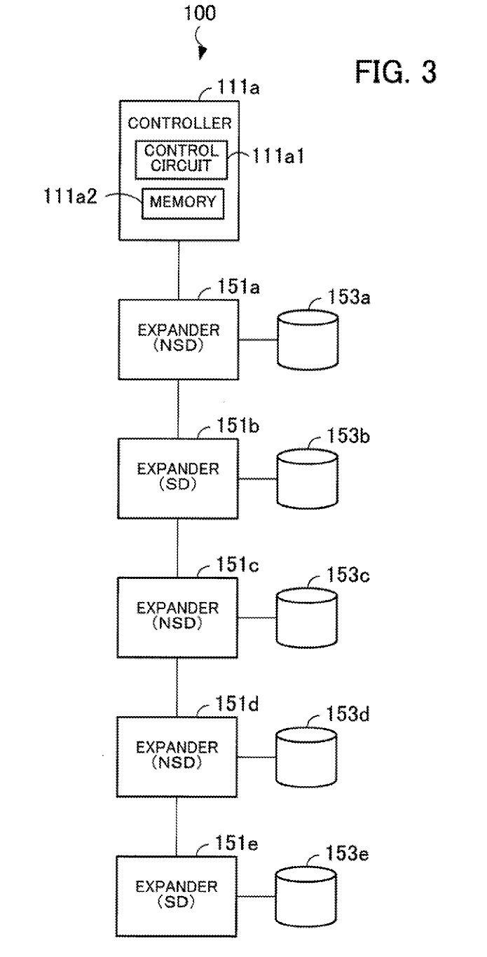

FIG. 3 illustrates the connection between the controller, the expanders, and the storage devices in the storage system according to the second embodiment. Hereinafter, in the storage system 100 according to the second embodiment, the controller 111a, the EXPs 151a to 151e, and the storage devices 153a to 153e are supposed to be connected to each other as illustrated in FIG. 3.

Specifically, the controller 111a is directly connected to the EXP 151a. The EXP 151a is directly connected to the controller 111a, the EXP 151b, and the storage device 153a. The EXP 151b is directly connected to the EXPs 151a and 151c, and the storage device 153b. The EXP 151c is directly connected to the EXPs 151b and 151d, and the storage device 153c. The EXP 151d is directly connected to the EXPs 151c and 151e, and the storage device 153d. The EXP 151e is directly connected to the EXP 151d and the storage device 153e. The controller 111a further has the control circuit 111a1 and the memory 111a2. The control circuit 111a1 functions as a controller. The memory 111a2 functions as a storage unit.

The EXPs 151a, 151c, and 151d are each supposed to fail to create and update the routing table by its own device, and receive the routing table created and updated by the controller 111a and operate in the NSD mode for setting the routing table for its own device. The EXPs 151b and 151e are each supposed to create and update the routing table by its own device as well as operate in the SD mode for setting the routing table.

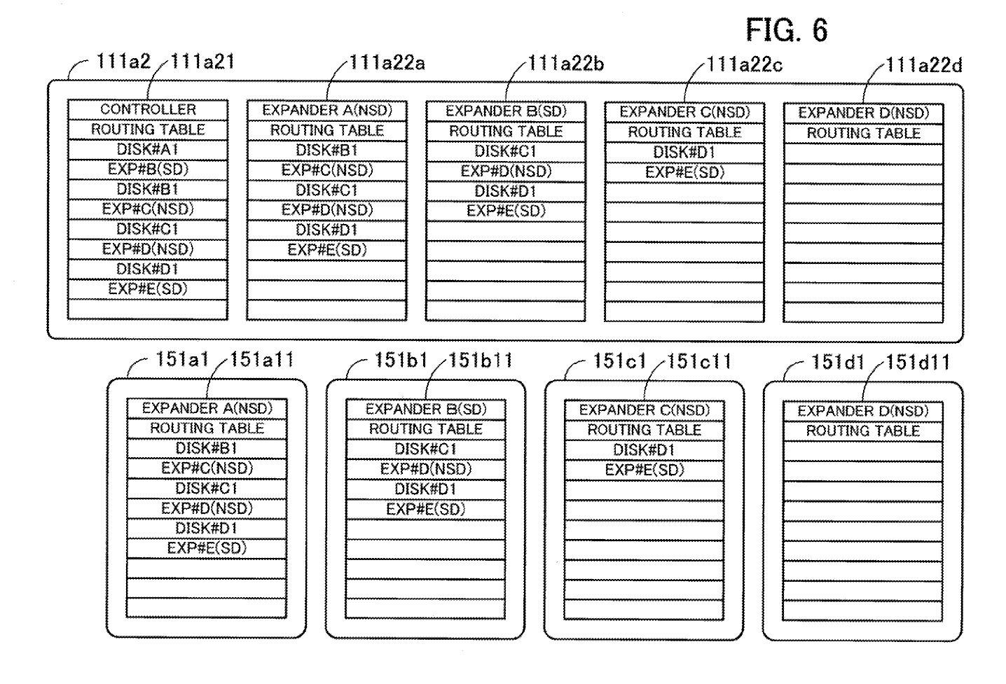

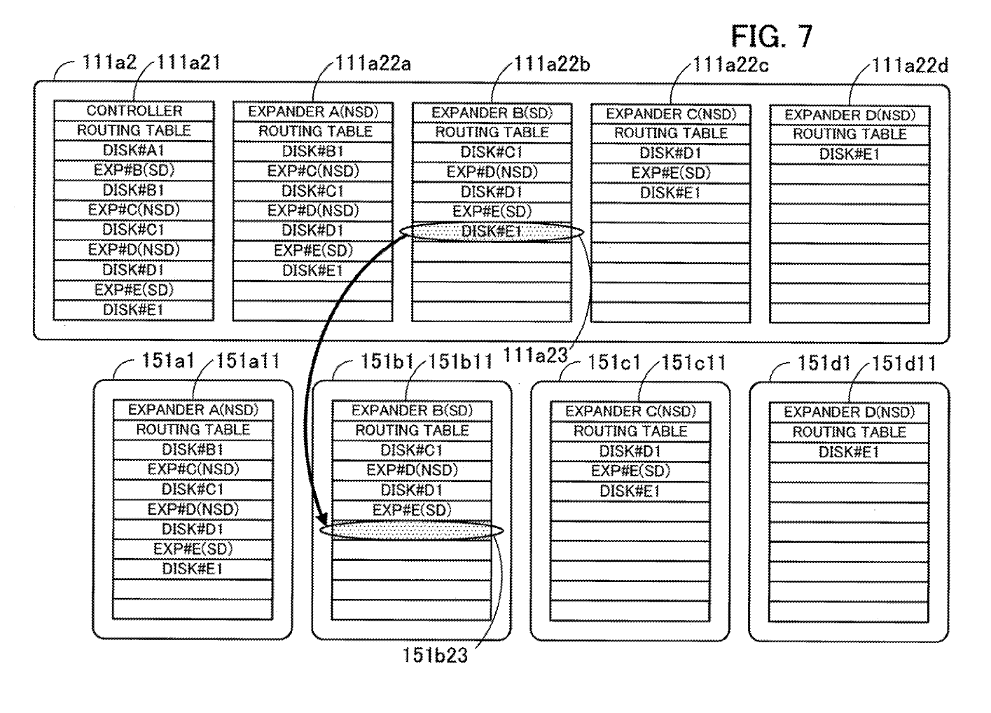

In the case where a device (e.g., the storage device 153e) is newly connected to a subordinate of its own device, the control circuit 111a1 creates the routing table according to each connection state of the EXPs 151a to 151e. The control circuit 111a1 acquires the routing table indicating a device connected to the EXP 151b, created by the EXP 151b which operates in the SD mode among the EXPs 151a to 151e of the subordinate. The control circuit 111a1 compares the acquired routing table and the routing table for a subordinate expander (hereinafter, referred to as the subordinate expander routing table) according to the connection state of the EXP 151a, corresponding to the EXP 151a, stored in the memory 111a2. Based on the comparison results, the control circuit 111a1 transmits a reset instruction of the routing table to the EXP 151b. A specific comparison method will be described in detail later with reference to FIGS. 6 and 7.

The control circuit 111a1 acquires each routing table with respect to the EXPs 151b and 151e operating in the SD mode, and at the same time, compares the acquired routing tables and the routing tables for the controller 111a. Based on the comparison results, the control circuit 111a1 transmits a reset instruction of each routing table to the EXPs 151b and 151e. The control circuit 111a1 fails to perform comparison of the routing table with respect to the EXPs 151a, 151c, and 151d operating in the NSD mode. The control circuit 111a1 creates the routing table according to each connection state and transmits it to the EXPs 151a, 151c, and 151d, thus setting the routing table according to the connection state.

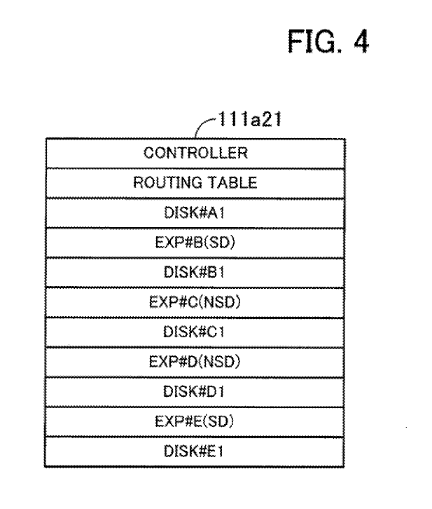

FIG. 4 illustrates the routing table for the controller according to the second embodiment. The routing table 111a21 illustrated in FIG. 4 is a routing table which stores the connection information indicating devices connected to the controller 111a, and stored in the memory 111a2 of the controller 111a. When a power switch of the storage system 100 is turned on, the routing table 111a21 is set by the controller 111a. The routing table 111a21 is further updated based on detection of a change in the connection state of each device through the controller 111a.

In the routing table 111a21, a device indirectly connected to the controller 111a via an expander is set. Specifically, in the routing table 111a21, a device directly connected to the controller 111a is not set as in the EXP 151a.

Specifically, in the routing table 111a21, when a power switch of the storage system 100 is turned on, the following are set by the controller 111a based on a response from a subordinate expander with respect to a request from the controller 111a of information indicating the connected device: that is, “DISK#A1” indicating the storage device 153a, “EXP#B(SD)” indicating the EXP 151b operating in the SD mode, “DISK#B1” indicating the storage device 153b, “EXP#C(NSD)” indicating the EXP 151c operating in the NSD mode, “DISK#C1” indicating the storage device 153c, “EXP#D(NSD)” indicating the EXP 151d operating in the NSD mode, “DISK#D1” indicating the storage device 153d, “EXP#E(SD)” indicating the EXP 151e operating in the SD mode, and “DISK#E1” indicating the storage device 153e. When the connection state to the storage system 100 of each device is changed, the routing table 111a21 is updated by the controller 111a based on the notification from the subordinate expander which detects a change in the connection state.

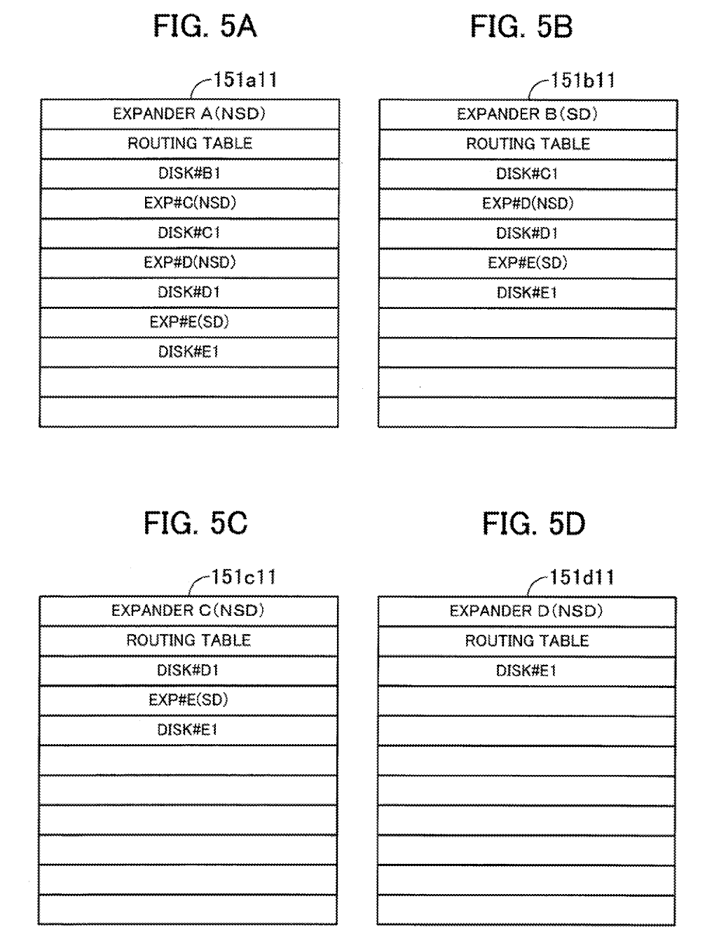

FIGS. 5A to 5D illustrate the routing tables for the expanders according to the second embodiment. The routing table 151a11 illustrated in FIG. 5A is a routing table which stores the connection information indicating a device connected to the EXP 151a, and stored in the memory 151a1. The routing table 151b11 illustrated in FIG. 5B is a routing table which stores the connection information indicating a device connected to the EXP 151b, and stored in the memory 151b1. The routing table 151c11 illustrated in FIG. 5C is a routing table which stores the connection information indicating a device connected to the EXP 151c, and stored in the memory 151c1. The routing table 151d11 illustrated in FIG. 5D is a routing table which stores the connection information indicating a device connected to the EXP 151d, and stored in the memory 151d1.

In the routing tables 151a11 to 151d11 illustrated in FIGS. 5A to 5D, a device indirectly connected to its own device is set through a subordinate expander of its own device, which stores the routing table. In other words, in the routing tables 151a11 to 151d11, a device directly connected to its own device is not set. Further, since a subordinate expander is not present in the EXP 151e and a device indirectly connected to its own device is not present, a device is not set in the routing table. Therefore, the description of the routing table for the EXP 151e will not be repeated.

Specifically, the storage device 153b, EXP 151c, storage device 153c, EXP 151d, storage device 153d, EXP 151e, and storage device 153e indirectly connected to the EXP 151a through the subordinate EXPs 151b to 151e are set in the routing table 151a11 illustrated in FIG. 5A. As described later, since the EXP 151a operates in the NSD mode, when a power switch of the storage system 100 is turned on, the routing table 151a11 is set by the controller 111a based on transmission from a subordinate routing table corresponding to the EXP 151a from the controller 111a. When the connection state to the storage system 100 of each device is changed, the routing table 151a11 is further updated by the controller 111a based on a notification from a subordinate expander which detects a change in the connection state.

The storage device 153c, EXP 151d, storage device 153d, EXP 151e, and storage device 153e indirectly connected to the EXP 151b through the subordinate EXPs 151c to 151e are set in the routing table 151b11 illustrated in FIG. 5B. As described later, since the EXP 151b operates in the SD mode, when a power switch of the storage system 100 is turned on, the routing table 151b11 is set by the EXP 151b. During the reception of BROADCAST (Change) (hereinafter, referred to as BC (CHG)) from a subordinate expander described later or DISCOVER from the controller 111a, the routing table 151b11 is further updated by the EXP 151b.

The storage device 153d, EXP 151e, and storage device 153e indirectly connected to the EXP 151c through the subordinate EXPs 151d and 151e are set in the routing table 151c11 illustrated in FIG. 5C. As described later, since the EXP 151c operates in the NSD mode, when a power switch of the storage system 100 is turned on, the routing table 151c11 is set by the controller 111a based on the transmission from a subordinate routing table corresponding to the EXP 151c from the controller 111a. When the connection state to the storage system 100 of each device is changed, the routing table 151c11 is further updated by the controller 111a based on a notification from a subordinate expander which detects a change in the connection state.

The storage device 153d indirectly connected to the EXP 151d through the subordinate EXP 151e is set in the routing table 151d11 illustrated in FIG. 5D. As described later, since the EXP 151d operates in the NSD mode, when a power switch of the storage system 100 is turned on, the routing table 151d11 is set by the controller 111a based on the transmission from a subordinate routing table corresponding to the EXP 151d from the controller 111a. When the connection state to the storage system 100 of each device is changed, the routing table 151d11 is updated by the controller 111a based on a notification from a subordinate expander which detects a change in the connection state.

FIGS. 6 and 7 illustrate the comparison of the routing tables according to the second embodiment. In the case where the storage device 153e is newly connected to the EXP 151e, operations at the time of comparing the routing table 111a21 and subordinate expander routing tables 111a22a to 111a22d stored in the memory 111a2 of the controller 111a with the routing tables 151a11 to 151d11 for the EXPs 151a to 151d will be described with reference to FIGS. 6 and 7. Here, the description of the routing table for the EXP 151e will not be repeated in the same manner as in FIGS. 5A to 5D. Here, FIG. 6 illustrates the routing tables and subordinate expander routing tables before connecting the storage device 153e to the EXP 151e. FIG. 7 further illustrates the routing tables and subordinate expander routing tables in which after connecting the storage device 153e to the EXP 151e, abnormality occurs in the routing table 151b11, and is not yet eliminated.

As illustrated in FIG. 6, the memory 111a2 stores the routing table 111a21 for the controller 111a at the time when the storage device 153e is not connected to the EXP 151e. The memory 111a2 further stores the subordinate expander routing tables 111a22a to 111a22d indicating the routing tables for the EXPs 151a to 151d in the case where the routing tables are correctly set in the connection state at this time. The controller 111a creates and updates the subordinate expander routing tables 111a22a to 111a22d according to the latest connection state based on the routing table 111a21. The memories 151a1 to 151d1 further store the real routing tables 151a11 to 151d11 for the EXPs 151a to 151d at the time when the storage device 153e is not connected to the EXP 151e.

Here, in the storage system 100, the storage device 153e is supposed to be newly connected to the subordinate EXP 151e of the controller 111a. In this case, when detecting the connection to the storage device 153e, the EXP 151e transmits to the EXP 151d a BC (CHG) for instructing it to create topology (SAS topology) of the storage system 100 again.

When receiving the BC (CHG) from the EXP 151e, the EXP 151d transmits it to the EXP 151c. Since operating in the NSD mode, the EXP 151d fails to update the routing table 151d11. Therefore, the storage device 153e is not set in the routing table 151d11 at this time.

When receiving the BC (CHG) from the EXP 151d, the EXP 151c transmits it to the EXP 151b. Since operating in the NSD mode, the EXP 151c fails to update the routing table 151c11. Therefore, the storage device 153e is not set in the routing table 151c11 at this time.

When receiving the BC (CHG) from the EXP 151c, since operating in the SD mode, the EXP 151b acquires the routing table 151c11 for the EXP 151c and updates the routing table 151b11 based on the received BC (CHG). At this time, when all of the subordinate EXPs 151c to 151e of the EXP 151b operate in the SD mode, the storage device 153e is set in each of the routing tables 151c11 to 151e11 from the EXP 151e to the EXP 151c in reverse. Therefore, the EXP 151b acquires the routing table 151c11 and sets the storage device 153e in the routing table 151b11. However, at this time, the storage device 153e is not set in the above-described routing table 151c11. Therefore, in the update through the EXP 151b, the storage device 153e is not set in the routing table 151c11. Next, the EXP 151b transmits the BC (CHG) to the EXP 151a.

When receiving the BC (CHG) from the EXP 151b, the EXP 151a transmits it to the controller 111a. Since operating in the NSD mode, the EXP 151a fails to update the routing table 151a11. Therefore, the storage device 153e is not set in the routing table 151a11 at this time.

Here, when receiving the BC (CHG) from the EXP 151a, the controller 111a transmits DISCOVER to the subordinate EXPs 151a to 151e. The subordinate EXPs 151a to 151e each transmit a response for the DISCOVER to the controller 111a. At this time, the EXPs 151a to 151e respond including information relating to each device connected to subordinates of its own device and information indicating that its own device operates in the SD mode or in the NSD mode. Examples of the information relating to each device connected to subordinates of its own device included in the response from the EXPs 151a to 151e include a type and peculiar identification data of devices connected to its own device and information indicating connection ports to devices connected to its own device.

Based on the information indicating the connection ports to devices connected to its own device, the controller 111a determines a configuration (each device is newly connected or the connection is released, and each device is directly or indirectly connected to any of devices) of the connection between the EXPs 151a to 151e and the storage devices 153a to 153e in the storage system 100. Based on the response from the EXPs 151a to 151e for the DISCOVER, the controller 111a recognizes whether the EXPs 151a to 151e each operate in the SD mode or in the NSD mode. In the memory 111a2, the controller 111a stores information indicating determination results of the connection state of each device in the storage system 100 and recognition results of the mode in which the EXPs 151a to 151e operate. In addition, the controller 111a may acquire, but without being limited thereto, the mode in which the EXPs 151a to 151e operate based on a response for a first DISCOVER after start of the operation, a response for the first DISCOVER after a first start of each expander, and other control signals.

Next, as illustrated in FIG. 7, the controller 111a determines a connection state of each device of the storage system 100 based on a response from the EXPs 151a to 151e. The controller 111a updates the routing table 111a21 stored in the memory 111a2 of the controller 111a at the time after newly connecting the storage device 153e to the EXP 151e. The above processing permits the storage device 153e to be set in the routing table 111a21. The controller 111a updates the subordinate expander routing tables 111a22a to 111a22d stored in the memory 111a2 based on the updated routing table 111a21. The above processing permits the storage device 153e to be set in the subordinate expander routing tables 111a22a to 111a22d. Here, as indicated in the connection information 111a23, the storage device 153e is set also in the subordinate expander routing table 111a22b corresponding to the EXP 151b.

At this time, the controller 111a excludes the EXP 151b and storage device 153a directly connected to the EXP 151a from the updated routing table 111a21, thereby creating the subordinate expander routing table 111a22a corresponding to the EXP 151a. The controller 111a further excludes the EXP 151c and storage device 153b directly connected to the EXP 151b from the created subordinate expander routing table 111a22a, thereby creating the subordinate expander routing table 111a22b corresponding to the EXP 151b. At this time, based on the information indicating connection ports to devices connected to the EXPs 151a to 151e included in responses from the EXPs 151a to 151e for the DISCOVER, the controller 111a determines a connection configuration of the subordinate devices, and excludes the EXP 151c and storage device 153b directly connected to the EXP 151b.

The controller 111a further excludes the EXP 151d and storage device 153c directly connected to the EXP 151c from the created subordinate expander routing table 111a22b, thereby creating the subordinate expander routing table 111a22c corresponding to the EXP 151c. The controller 111a further excludes the EXP 151e and storage device 153d directly connected to the EXP 151d from the created subordinate expander routing table 111a22c, thereby creating the subordinate expander routing table 111a22d corresponding to the EXP 151d.

Next, the controller 111a allows the EXPs 151a, 151c, and 151d operating in the NSD mode to update the routing tables. At this time, the controller 111a transmits the corresponding subordinate expander routing tables 111a22a, 111a22c, and 111a22d to the EXPs 151a, 151c, and 151d operating in the NSD mode, respectively. The controller 111a then allows the EXPs 151a, 151c, and 151d to update the routing tables 151a11, 151c11, and 151d11, respectively. On the other hand, the controller 111a fails to transmit the routing tables to the EXPs 151b and 151e operating in the SD mode, so that they are not updated.

Therefore, the storage device 153e is not set in the routing table 151b11 and, if nothing is done, the EXP 151c fails to access the storage device 153e. As compared with the above, with respect to the EXPs 151b and 151e operating in the SD mode, the controller 111a according to the second embodiment compares the routing tables and the corresponding subordinate expander routing tables (e.g., the subordinate expander routing table 111a22b), respectively. When the routing table is not matched with the subordinate expander routing table, the controller 111a transmits to the above expanders the DISCOVER being a reset instruction for allowing them to create routing tables in an SMP (SAS Management Protocol) FUNCTION.

Next, in the EXP 151b of FIG. 7, the storage device 153b is not set in the routing table 151b11 as illustrated in the connection information 151b23. As compared with the above, as illustrated in the connection information 111a23, the storage device 153e is set in the subordinate expander routing table 111a22b. Therefore, the routing table 151b11 is not matched with the subordinate expander routing table 111a22b, so that the controller 111a transmits to the EXP 151b the DISCOVER being a reset instruction for allowing it to create a routing table.

When receiving the DISCOVER transmitted from the controller 111a, the EXPs 151b and 151e create routing tables for its own device.

Here, in FIG. 7, the controller 111a allows the EXP 151c to complete update of the routing table 151c11, and the storage device 153e is set therein. Therefore, when the EXP 151b acquires and updates the routing table 151c11, the storage device 153e is set therein as illustrated in the connection information 151b23.

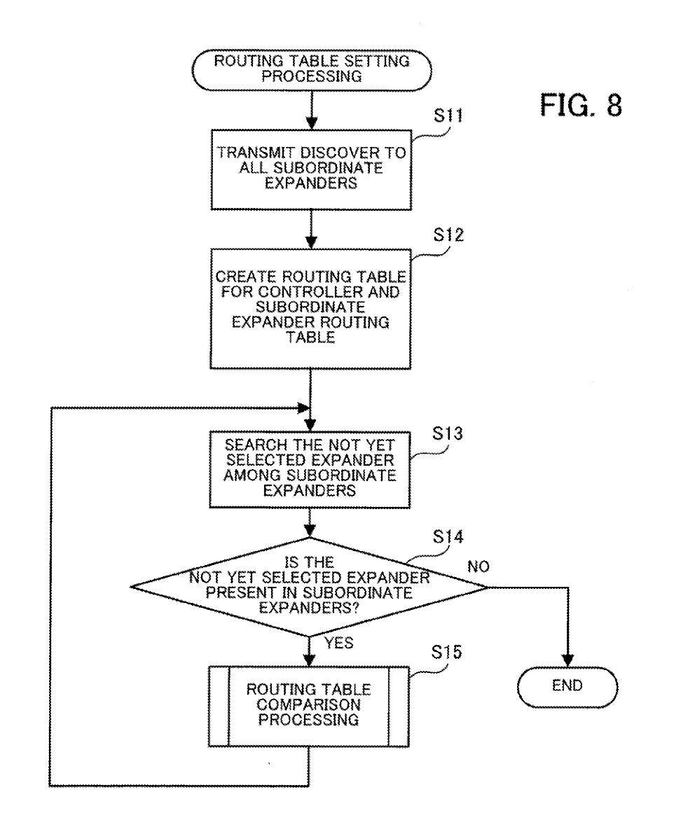

FIG. 8 illustrates routing table setting processing according to the second embodiment. The control circuit 111a1 according to the second embodiment is supposed to receive a BC (CHG) from an expander (e.g., the EXP 151e) to which a device (e.g., the storage device 153e) is newly connected, and detect that the storage device 153e is connected to the EXP 151e. In this case, the control circuit 111a1 performs the routing table setting processing for setting (updating) each routing table (e.g., routing tables 151a11 to 151d11) for the EXPs 151a to 151d. The description of the routing table for the EXP 151e will not be repeated in the same manner as in FIGS. 5A to 5D. The routing table setting processing illustrated in FIG. 8 includes the following steps of a flowchart:

(Step S11) The control circuit 111a1 transmits to all of the subordinate EXPs 151a to 151e the DISCOVER for allowing them to update the routing tables. The EXPs 151a to 151e receiving the DISCOVER each transmit a response for the DISCOVER to the controller 111a. This response includes information indicating that a mode in which its own device operates is either the SD mode or the NSD mode, and information indicating a connection port between its own device and the connected device in the EXPs 151a to 151e. Based on the information included in this response, the control circuit 111a1 determines each mode of the EXPs 151a to 151e and the connection state (both of the connected devices are connected directly or indirectly) between both respective devices.

(Step S12) The control circuit 111a1 creates the routing table 111a21 and subordinate expander routing tables 111a22a to 111a22d of the controller 111a, and stores them in the memory 111a2. The control circuit 111a1 further sets the created routing table 111a21 in the routing table for its own device.

(Step S13) The control circuit 111a1 searches a loop of steps S13 to S15 for the presence or absence of the not yet selected expander among the subordinate EXPs 151a to 151e.

(Step S14) The control circuit 111a1 determines based on step S13 whether the not yet selected expander is present in the subordinate EXPs 151a to 151e. If so (Yes at step S14), the process proceeds to step S15. On the other hand, if not (No at step S14), the process terminates.

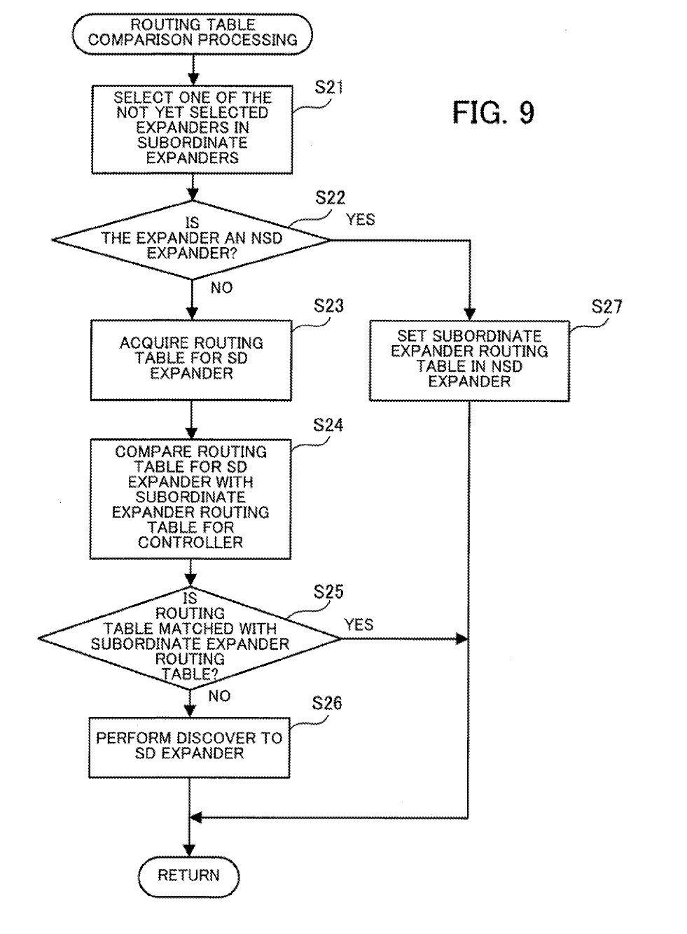

(Step S15) The control circuit 111a1 performs comparison processing for transmitting the subordinate expander routing table to the NSD expander and allowing the SD expander to perform the DISCOVER, in which the not yet selected expander will be described later with reference to FIG. 9.

FIG. 9 illustrates the routing table comparison processing according to the second embodiment. In the second embodiment, the control circuit 111a1 transmits the subordinate expander routing table to the NSD expander and allows the SD expander to perform the DISCOVER based on the comparison results between the routing table and the subordinate expander routing table. Through the above process, the control circuit 111a1 performs the routing table comparison processing for setting a routing table for an expander. The description of the routing table for the EXP 151e will not be repeated in the same manner as in FIGS. 5A to 5D. The routing table comparison processing illustrated in FIG. 9 includes the following steps of a flowchart:

(Step S21) The control circuit 111a1 selects one of the not yet selected expanders in the subordinate expanders 151a to 151e.

(Step S22) The control circuit 111a1 determines whether the expander selected at step S21 is an NSD expander operating in the NSD mode. If so (Yes at step S22), the process advances to step S27. On the other hand, if not (No at step S22), the process proceeds to step S23.

(Step S23) The control circuit 111a1 acquires the routing table set in the expander selected at step S21 being an SD expander. For example, when the expander 151b is selected, the control circuit 111a1 acquires the routing table 151b11.

(Step S24) The control circuit 111a1 compares the routing table 151b11 for the EXP 151b selected at step S21 being the SD expander and the subordinate expander routing table 111a22c indicating the connection information to be set in the EXP 151b.

(Step S25) The control circuit 111a1 determines whether the routing table 151b11 and the subordinate expander routing table 111a22c are matched with each other in the comparison result of step S24. If so (Yes at step S25), the process returns to the routing table setting processing. On the other hand, if not (No at step S25), the process proceeds to step S26.

(Step S26) The control circuit 111a1 transmits a reset instruction for allowing the EXP 151b to reset the routing table 151b11 and perform the DISCOVER to the EXP 151b selected at step S21 being the SD expander. Through the above process, the EXP 151b performs the DISCOVER and creates the routing table 151b11 again. Accordingly, the EXP 151b acquires connection information from the routing tables for the subordinate EXPs 151c to 151e of the EXP 151b, and sets a newly connected storage device 153e in the routing table 151b11. Based on this setting, the EXP 151b accesses the storage device 153e. The process then returns to the routing table setting processing.

(Step S27) Among the subordinate expander routing tables 111a22a to 111a22d stored in the memory 111a2 created at step S12 of the routing table setting processing, the control circuit 111a1 sets the corresponding subordinate expander routing table in the expander selected at step S21 being the NSD expander. For example, when the EXP 151a is selected, the control circuit 111a1 sets the subordinate expander routing tables 111a22a in the EXP 151a. The process then returns to the routing table setting processing.

Here, in the routing table comparison processing according to the second embodiment, at step S21, the controller 111a selects an expender with no distinction of the SD expander and the NSD expander. The controller 111a may select, but without being limited thereto, all the NSD expanders and then select the SD expanders. As a result, the connection of a new device is completely reflected on a routing table for the NSD expander, and then the controller 111a allows the SD expander to update the routing table.

The controller 111a compares a routing table indicating a latest state of a device connected to the storage system 100 and a subordinate expander. In the case where a new device is connected, even if abnormality of the routing table 151b11 for the EXP 151b operating in the SD mode occurs, this feature of the controller 111a detects the abnormality and eliminates it.

With regard to the NSD expander, since failing to compare the routing tables for the NSD expander and the corresponding subordinate expander routing tables, the controller 111a suppresses a processing load from increasing at the time of the connection of a new device.

With regard to the SD expander, the controller 111a compares the routing tables for the SD expander and the subordinate expander routing tables created by the controller 111a to detect abnormality. With regard to the NSD expander, since setting the subordinate expander routing tables, when performing a process corresponding to a mode of the expander, the controller 111a suppresses a processing load from increasing at the time of the connection of a new device.

When detecting that a new device is connected to a subordinate, the controller 111a compares the routing table 151b11 for the EXP 151b selected at step S21 being the SD expander and the subordinate expander routing table 111a22c indicating the connection information to be set in the EXP 151b. Therefore, even if abnormality of the routing table for the SD expander occurs at the time of connection of a new device, the controller 111a suppresses the abnormality of the routing table from continuing.

In the case where a new device is connected to a subordinate, the controller 111a creates the subordinate expander routing tables 111a22a to 111a22d indicating the routing tables to be set in the subordinate SD expander, and compares the routing tables for the subordinate expanders and the corresponding subordinate expander routing tables. As a result, the controller 111a eliminates abnormality of the routing table 151b11 for the EXP 151b operating in the SD mode, and accesses the storage device 153e newly connected to the EXP 151b.

### Modification of Second Embodiment

Next, a modification of the second embodiment will be described. The modification will be described with a focus on a difference from the second embodiment, and the description of the same matters will not be repeated. In the routing table comparison processing, the storage system according to the second embodiment compares also a routing table for the NSD expander with a subordinate expander routing table for the controller. The modification differs from the second embodiment in the point that it is confirmed that the routing table for the NSD expander is normally set.

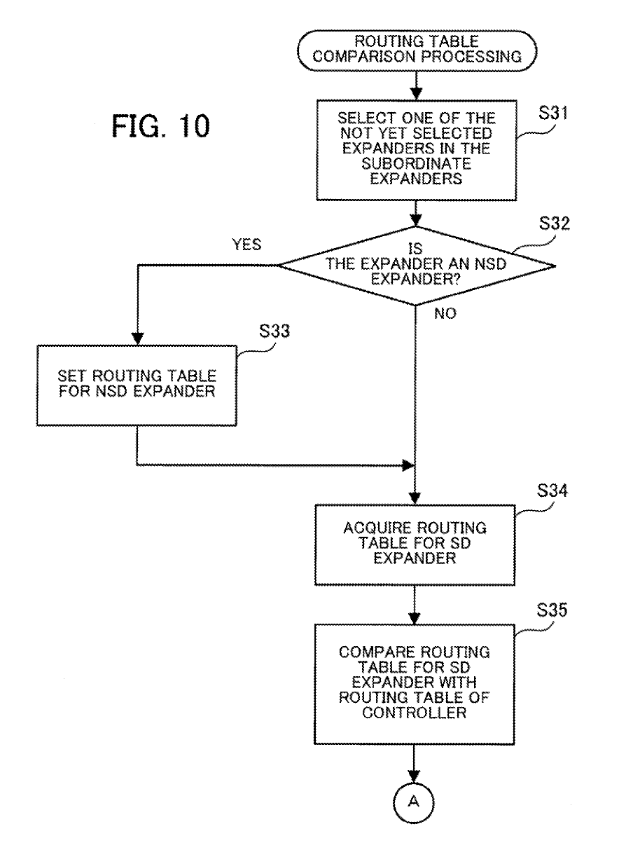

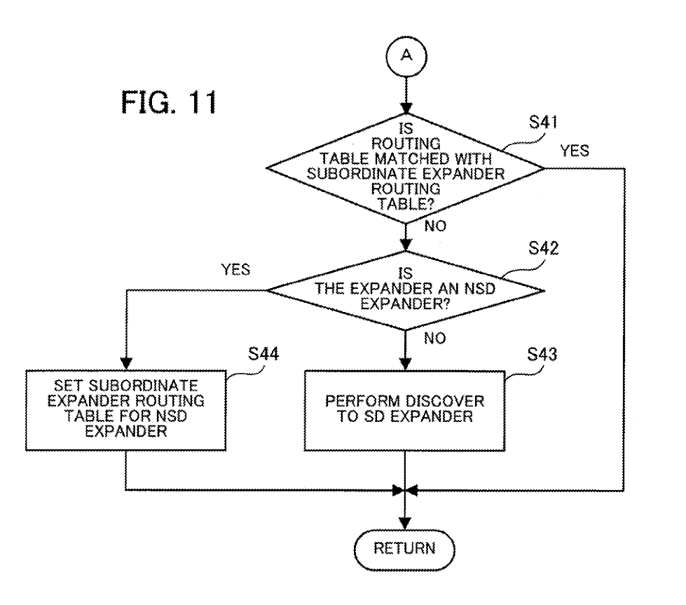

FIGS. 10 and 11 illustrate the routing table comparison processing of the modification of the second embodiment. In the modification of the second embodiment, the control circuit 111a1 transmits the subordinate expander routing table to the NSD expander and allows the SD expander to perform the DISCOVER, thus setting a routing table for the expander. Based on the comparison result between the routing table for the expander and the subordinate expander routing table, the control circuit 111a1 performs the routing table comparison processing for confirming that after the setting, the setting is correctly performed. The description of the routing table for the EXP 151e will not be repeated in the same manner as in FIGS. 5A to 5D. The routing table comparison processing illustrated in FIGS. 10 and 11 includes the following steps of a flowchart:

(Step S31) The control circuit 111a1 selects one of the not yet selected expanders in the subordinate EXPs 151a to 151e.

(Step S32) The control circuit 111a1 determines whether the expander selected at step S31 is an NSD expander. If so (Yes at step S32), the process advances to step S33. On the other hand, if not (No at step S32), the process proceeds to step S34.

(Step S33) Among the subordinate expander routing tables 111a22a to 111a22d stored in the memory 111a2 prepared at step S12 of the routing table setting processing, the control circuit 111a1 sets the subordinate expander routing table corresponding to the expander selected at step S31 being an NSD expander. The process then proceeds to step S34.

(Step S34) The control circuit 111a1 acquires the routing table set in the expander selected at step S31 being an SD expander.

(Step S35) The control circuit 111a1 compares the routing table 151b11 for the EXP 151b selected at step S31 being an SD expander and the subordinate expander routing table 111a22c indicating the connection information to be set in the EXP 151b.

(Step S41) The control circuit 111a1 determines whether the routing table 151b11 and the subordinate expander routing table 111a22c are matched with each other in the comparison result of step S35. If so (Yes at step S41), the process returns to the routing table setting processing. On the other hand, if not (No at step S41), the process proceeds to step S42.

(Step S42) The control circuit 111a1 determines whether the expander selected at step S31 is an NSD expander. If so (Yes at step S42), the process advances to step S44. On the other hand, if not (No at step S42), the process proceeds to step S43.

(Step S43) The control circuit 111a1 transmits a reset instruction for allowing the EXP 151b to reset the routing table 151b11 and perform the DISCOVER to the EXP 151b selected at step S31 being the SD expander. Through the above process, the EXP 151b performs the DISCOVER and creates the routing table 151b11 again. Accordingly, the EXP 151b acquires connection information from the routing tables for the subordinate EXPs 151c to 151e of the EXP 151b, and sets a newly connected storage device 153e in the routing table 151b11. Based on this setting, the EXP 151b accesses the storage device 153e. The process then returns to the routing table setting processing.

(Step S44) Among the subordinate expander routing tables 111a22a to 111a22d stored in the memory 111a2 created at step S12 of the routing table setting processing, the control circuit 111a1 sets the subordinate expander routing table corresponding to the expander selected at step S31 being the NSD expander. The process then returns to the routing table setting process.

Here, in the routing table comparison processing of the modification of the second embodiment, the control circuit 111a1 selects an expander with no distinction of the SD expander and the NSD expander at step S31. The control circuit 111a1 may select, but without being limited thereto, all the NSD expanders and then select the SD expanders. As a result, the connection of a new device is completely reflected on the routing table for the NSD expander, and then the control circuit 111a1 allows the SD expander to update the routing table.

The above-described storage system 100 of the modification of the second embodiment has the same effect as that of the second embodiment.

The storage system 100 compares a routing table newly set in the NSD expander after updating the routing table for the NSD expander and a routing table indicating a state of a device connected to the latest storage system 100. Through the above process, the storage system 100 confirms that the routing table 151b11 for the EXP 151b is normally set. In the case where abnormality is detected, when setting is performed again, the storage system 100 eliminates abnormality of a routing table for an NSD expander.

As can be seen from two embodiments discussed above, the proposed control apparatus, storage system, and control method permit abnormality of connection information of a relay device to be eliminated.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that various changes, substitutions and alterations could be made hereto without departing from the spirit and scope of the invention.

What is claimed is:

1. A control apparatus for performing data access to a storage device by the relay of data access of a relay device, the control apparatus comprising:
a memory configured to store first connection information indicating devices connected to subordinates of the control apparatus; and
a processor configured to acquire second connection information, created by the relay device, indicating devices connected to the relay device, compare the acquired second connection information and the first connection information stored in the memory, and transmit a reset instruction on the second connection information to the relay device based on a comparison result.

2. The control apparatus according to claim 1, wherein the processor acquires, with respect to a first relay device which creates the second connection information, the second connection information as well as performs the comparison, and transmits a reset instruction on the second connection information to the first relay device based on a comparison result, and creates, with respect to a second relay device which fails to create the second connection information, third connection information indicating connection information according to a connection state of the second relay device to store the created third connection information in the memory, and transmits the third connection information stored in the memory to the second relay device to set the transmitted third connection information.

3. The control apparatus according to claim 1, wherein in the case where a device is newly connected to a subordinate of the control apparatus, the processor acquires the second connection information, created by the relay device, indicating devices connected to the relay device, compares the acquired second connection information and the first connection information stored in the memory, and transmits the reset instruction to the relay device based on a comparison result.

4. The control apparatus according to claim 1, wherein the processor creates the third connection information indicating connection information according to a connection state of the relay device to store the created third connection information in the memory, acquires the second connection information, compares the acquired second connection information and the third connection information stored in the memory, and transmits the reset instruction to the relay device based on a comparison result.

5. The control apparatus according to claim 2, wherein the processor transmits and sets the third connection information to the second relay device, acquires the third connection information set to the second relay device as well as performs the comparison, and transmits and sets the third connection information to the second relay device based on a comparison result.

6. A storage system for allowing a control apparatus to perform data access to a storage device by the relay of data access of a relay device, the storage system comprising:
a relay device which includes a second memory which stores second connection information indicating devices connected to subordinates of the control apparatus, and
which creates the second connection information to store the created second connection information in the second memory, and connects to another device based on the second connection information stored in the second memory; and
a control apparatus which includes a first memory which stores first connection information indicating devices connected to subordinates of the control apparatus, and
a processor which acquires the second connection information, compares the acquired second connection information and the first connection information stored in the first memory, and transmits a reset instruction on the second connection information to the relay device based on a comparison result.

7. A control method for performing data access to a storage device by the relay of data access of a relay device, the control method comprising:
acquiring second connection information, created by the relay device, indicating devices connected to the relay device;
comparing the acquired second connection information and first connection information indicating devices connected to subordinates of a control apparatus; and
transmitting a reset instruction on the second connection information to the relay device based on a comparison result.
